(19) United States
(12) Patent Application Publication
(10) Pub. No.: US 2022/0222630 A1
(43) Pub. Date: Jul. 14, 2022

(54) EXTRACTING GUIDANCE RELATING TO A PRODUCT/SERVICE SUPPORT ISSUE BASED ON A LOOKUP VALUE CREATED BY CLASSIFYING AND ANALYZING TEXT-BASED INFORMATION

(71) Applicant: Hewlett Packard Enterprise Development LP, Houston, TX (US)

(72) Inventors: Bradley Sobotka, Ft. Collins, CO (US); David Blocker, Denver, CO (US); Carlos Antar Gutierrez Arriaga, Roseville, CA (US); Juan Carlos Zumbado Pardo, Heredia (CR)

(21) Appl. No.: 17/145,786

(22) Filed: Jan. 11, 2021

(51) Int. Cl. G06Q 10/00; G06Q 30/06; G06Q 30/02; G06F 16/906

(52) U.S. Cl. CPC G06Q 10/20; G06Q 30/0627; H04M 3/5183; G06Q 30/0281; G06F 16/906; G06Q 30/0637

(57) ABSTRACT

Embodiments described herein are generally directed to various use cases involving turning text data into actionable evidence. According to an example, text-based information relating to an issue associated with a product or service of a vendor is receive via a self-service SaaS portal and includes one or both of structured data and unstructured data. The text-based information is classified and analyzed by parsing out a first set of facts from the structured data. A second set of facts is identified by applying a taxonomy to the text-based information. A lookup value is created by aggregating the first and second sets of facts. Guidance, representing a proposed resolution of the issue, a recommended next troubleshooting step in connection with evaluation of the issue, or other guidance relating to the issue, is then extracted from a lookup table based on the lookup value.

### BACKGROUND

A great deal of business data is in the form of text. Examples of text-based business data include call center transcripts, which may be stored in case records, online reviews, customer surveys, and other text documents. By mining this data, businesses may, among other things, save operational costs, uncover relationships previously not available, and gain insights into future trends.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 shows a block diagram illustrating an architecture in accordance with an example embodiment.

FIG. 2 shows a block diagram illustrating data flow associated with a rules engine and a message delivery engine in accordance with an example embodiment.

FIG. 3 shows a flow diagram illustrating call center pre-population guidance processing in accordance with an example embodiment.

FIG. 4 shows a flow diagram illustrating guided trouble shooting as a service processing in accordance with an example embodiment.

FIG. 5 shows a block diagram of a computer system in accordance with a first example embodiment.

FIG. 6 shows a block diagram of a computer system in accordance with a second example embodiment.

### DETAILED DESCRIPTION

Embodiments described herein are generally directed to various use cases involving turning text data into actionable evidence. Numerous specific details are set forth in order to provide a thorough understanding of exemplary embodiments. It will be apparent, however, to one skilled in the art that embodiments described herein may be practiced without some of these specific details.

A call center may represent a centralized department to which inbound phone calls, text messages and/or email messages from current and potential customers are directed. Call centers may be located within a company or may be outsourced to another company that specializes in handling calls. In the context of call center handling product/service support, agents of the call center may field requests from customers regarding the products/services of a particular vendor and input text-based information relating to a behavior, an issue, and/or other item of interest of a particular product/service into a field of a case record.

Call center agents may be provided with scripts, decision trees, reference documents, and/or other resources to facilitate providing guidance to customers. Due to, among other factors, the complexity of various products/services, an inability to locate the right guidance, failure to consult the resources, and/or misunderstanding on the part of the agent of the customer issue, in a significant number of cases, the correct trouble shooting guidance may not be provided to the customer. In some circumstances, incorrect replacement parts may be sent to customers by call center agents in an effort to close a case in the quickest manner possible. In other circumstances, an issue referred to as “shot-gunning parts” is observed in which an agent or agents apply an excessive number of parts to a particular case. Overall, the combination of incredibly technical troubleshooting steps along with pressure to come up with a solution in a timely manner may lead to a sub-optimal way of trying to fix product/service issues being experienced by customers. The foregoing issues may result in significant costs to the vendor in terms of warranty expenses and may leave customers unsatisfied with the quality of the products/services at issue.

While some of the text-based information included within case records, auto-generated by software tools used by call center agents and/or input by the agents, may be highly structured (e.g., phone numbers, serial numbers, stock-keeping units (SKUs), error codes, and the like), other text-based information added to such case records may be unstructured. Because different persons have their own intricacies in the way they express information, the unstructured text-based information may not be captured in a consistent way from agent to agent or even from case to case by the same agent. This makes mining relevant information from the case records a challenge.

As described further below, various embodiments, seek to address various limitations associated with existing call center approaches. In one embodiment, various fields extracted from case records (e.g., case title and/or case notes) are analyzed using text analytics (e.g., regular expressions and/or taxonomy). Based upon the results of the text analytics, various of the case records may be proactively updated to include appropriate guidance for use by the call center agents in connection with assisting customers with product/service support issues. In some embodiments, other data sources (e.g., databases containing historical data, SKUs, serial numbers, identification of products models and/or software versions) may be used in addition to the case records to classify text-based information extracted therefrom. In yet another embodiment, a self-service solution may be provided for use by agents and/or customers. For example, in the context of troubleshooting issues with hardware or software products, customer may be provided with the ability to “self-solve” their issues using guided trouble shooting (GTS) as a service (GaaS) by inputting an error string output by the product/service at issue, a unique identifier (e.g., a case number), and/or uploading a file (e.g., an error log).

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not necessarily required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, a “call center” generally refers to the physical or virtual infrastructure that facilitates handling of customers service related communications. A call center may be located within an organization, outsourced to another organization, or a combination thereof. Some call centers may have a centralized physical location at which a high volume of customer and other telephone calls are handled by an organization, usually with some amount of computer automation. Other call centers may be more virtual in form to facilitate support for agents in various distributed geographic locations. While the traditional call center model focused on inbound and/or outbound phone calls, as used herein “call center” is intended to encompass additional channels and forms of communication including, but not limited to, email, in-app chat or video, text messaging (e.g., via short message service (SMS) or the like).

As used herein, the phrase “case record” is intended to broadly refer to a unit of case data maintained or otherwise utilized by a call center. Case records may include, among other fields, a title, a unique identifier (e.g., a case number), information identifying the product/service at issue, information identifying the model and/or version of the product/service at issue, and a free-form text field (e.g., a case notes field).

Reference in the specification to “one embodiment” or “an embodiment” means that a particular feature, structure, or characteristic described in connection with the embodiment can be included in at least one embodiment of the invention. The appearances of the phrase “in one embodiment” are not necessarily all referring to the same embodiment.

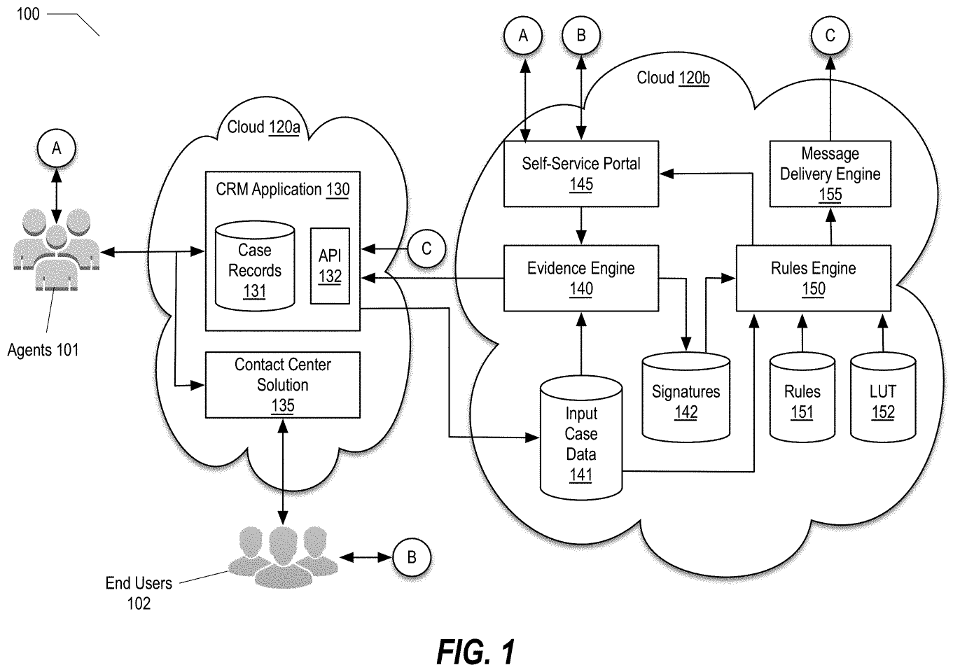

FIG. 1 shows a block diagram illustrating an architecture 100 in accordance with an example embodiment. While various examples provided herein are described in the context of call center agents (e.g., agents 101) assisting customers (e.g., end users 102) in connection with troubleshooting product/service issues, the methods and systems described herein are generally applicable to other processes involving text data. For example, text data, regardless of how complex the text is in presentation, who is writing the text, or where the text is in a document, may be turned into structured data that has use cases ranging from improved troubleshooting to unlocking data that can be used in machine learning.

In the context of the present example, the architecture 100 includes one or more clouds 120a-b, which may represent private or public clouds. Cloud 120a may be a public cloud through which a Customer Relationship Management (CRM) application 130 (e.g., Salesforce, Microsoft Dynamics 365, and Zoho CRM) and an associated contact center solution 135 are delivered as a service to the call center agents to, for example, facilitate handling and documentation of inbound communications from the customers of a vendor of a particular product or service. According to one embodiment, CRM application 130 includes a case records database 131 and an Application Programming Interface (API) 132. The case records database 131 may store case data, including case notes input in the form of text-based information by call center agents, relating to support issues raised by customers. For example, customers may communicate with the call center agents through various communication mechanisms (e.g., voice calls, video calls, and/or chat) supported by the contact center solution. Depending upon the particular implementation, API 132 may be a Representational State (REST) API through which interactions between the CRM application 130 and call center agents and other external systems may be handled.

Cloud 120b may be a private cloud of the vendor in which functionality may be implemented to, among other things, analyze case data extracted from the CRM application 130. In the context of the present example, cloud 120b includes a self-service portal 145, an evidence engine 140, a rules engine 150, and a message delivery engine 155.

In one embodiment, the evidence engine 140 is responsible for, among other things, periodically (e.g., every hour or few hours) receiving a subset of case records from the case records database 131 for processing. While in various examples described herein the processing involves performing various forms of text analytics on text data extracted from case records to facilitate delivery of guidance relating to product/service errors, problems, or other issues, the processing may be performed for other purposes. For example, case records meeting certain criteria may be extracted to identify patterns of behavior or symptoms across product lines or within a particular product line and/or to facilitate the creation of automation rules. With respect to the receipt of the subset of case records from the case records database 131, this may be as a result of the evidence engine 140 periodically requesting case records of interest via the API 132 for storage within an input case data database 141. Alternatively, the CRM application 130 may be configured to periodically push a subset of case records to the input case data database 141. The subset of case records may be filtered based on various factors (e.g., date/time of last update to the case record, whether the case record has previously been processed by the evidence engine 140, the title of the case record, the relationship of the case to a particular product/service or version thereof, the date on which the product was shipped to the customer, and correspondence of the case to a particular SKU).

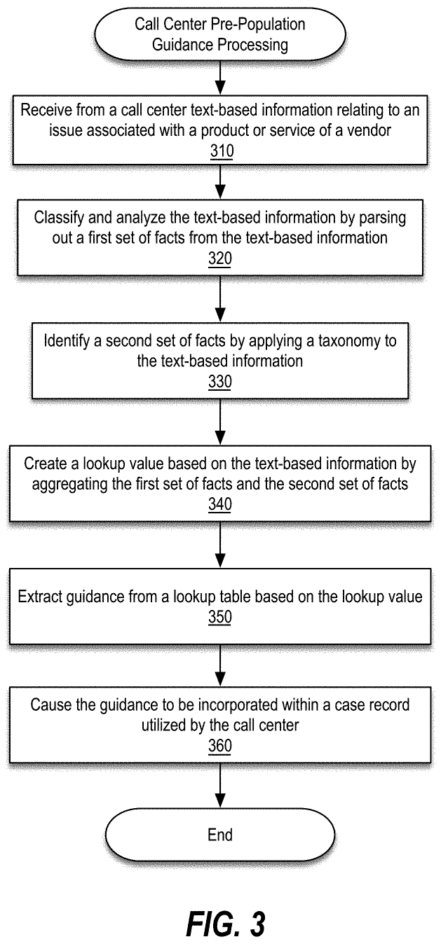

Depending upon the particular implementation, near real-time analytics, feedback to agents 101, and/or pre-population of guidance into case records within case records database 131 may be supported by gathering desired case records every hour or so. Further details regarding an example of call center pre-population guidance processing is provided below with reference to FIG. 3. As new case data is available within the input case database 141, the evidence engine 140 may turn unstructured text-based information contained within the case data into structured data. As described in further detail below, in one embodiment, the evidence engine 140 may apply multiple different technologies and text analytics methods to the text-based information. For example, the evidence engine 140 may use one or both of regular expressions and taxonomy.

Regular expressions may be used to classify and analyze text data by parsing out specific content from a larger portion of text. A non-limiting example of the use of regular expressions may involve finding all the phone numbers within a document using one or more basic structures for a phone number (e.g., (###) ###-####, ###.###.####, or the like). Regular expressions are particularly useful when applied to text data that is auto-generated or text that is consistent in the way it is presented. According to one embodiment, regular expressions are used to extract content that is highly structured by mining out the relevant information into “facts” that are contained within a text field. Non-limiting examples of “facts” in the context of a user calling into the call center to report a problem with their car running hot (referred to herein as an “engine hot” issue) may include:
An error code from a car's computer (e.g., the error code U3089 output by a code reader may translate to the output of the radiator registering a temperature above 2456 degrees Fahrenheit);
A temperature reading from a gauge. Assuming the gauge and sensor are working and calibrated properly, the readings from the temperature gauge can be collected to be reasonably sure that the car was operating between 240 and 250 degrees Fahrenheit.
A temperature warning light came on. There are certain pre-programmed parameters that are met to trigger this condition to occur (e.g., input of the radiator registering a temperature above 280 degrees Fahrenheit). Again, the assumption is that the sensor was working and calibrated properly and that there was not an error in the electrical system providing a false “on” reading.

Notably, when information is collected and documented in a case record by call center agents, such information cannot be relied upon to be presented in a consistent manner, as each human has their own intricacies in the way they write. For instance, continuing with the “engine hot” example, a call center agent may input the following sentence into a case notes field of a case record based on the description of a problem conveyed to the call center agent by the car owner:
My car's engine gets hot when I drive it more than 10 miles on the interstate in the summer.

Such text data is not considered to be a “fact” within the context of the present disclosure, but rather is referred to herein as a “behavior” or a “symptom” as this data represents a more general interpretation of the information being presented and may not represent, with a high likelihood or with sufficient precision, the real underlying problem. From a text mining standpoint, taxonomy may be used to classify text that can range from highly structured to highly variable in the way it can be presented. In one embodiment, taxonomy relies on the use of built-in functions that can specify what to look for and what to ignore in a document or a text field of interest. For example, in order to search text data contained within the respective case notes fields of a number of case records to identify how many people reported an engine heating up, regardless of other details, the following taxonomy may be used:
Near(4, engine, heat or hot)

This taxonomy represents a non-limiting example of a built-in function that may be used to classify a sentence, such as the one identified above, as an “engine hot” issue. The function “near” looks for at least two words within a certain range of each other. In this case, the taxonomy is looking for the word “engine” and “heat” or “hot” within four words of each other and disregards other extraneous details (e.g., that the user had to drive the car more than ten miles on the interstate or that it was during the summer). If these or other detail were relevant, the taxonomy could be modified to look for appropriate additional keywords. In this manner, the person (e.g., a subject matter expert (SME)) writing the rules is provided with a great deal of freedom to look for relevant facts in a document regardless of how the text-based information is presented.

According to one embodiment, another step in the classification phase performed by the evidence engine 140 may involve placing delimiters before each fact so that when automation and/or filtering rules are built based upon the presence of certain facts, the rule builder knows with certainty that the fact they are searching for is the fact they will find. Using the “engine hot” example, instead of calling the issue “Hot Engine,” a delimiter like “E_” (E for engine) may be prepended to the fact to, for example, distinguish the fact from the same or different fact associated with another type of issue. This step is useful when there are many facts in a case and provides the process with a layer of security to avoid potential misclassifications.

Depending upon the particular implementation, in addition to classifying structured and unstructured text, other classification techniques may be used. According to one embodiment, the evidence engine 140 may have the ability to find issues in a case that do not even mention the issue explicitly. For example, by tying in other data sources to a case that is not inherently about error messages or describing error messages, the evidence engine 140 may expand its issue-classification capabilities. Assuming, for example, if it is known that a particular product manufactured or shipped within a particular date range, having a particular range of serial numbers, or having a particular range of SKUs is likely to experience a particular issue or exhibit a particular behavior, the corresponding cases within a set of case records may be identified by correlating information contained within the case data with information from one or more other data sources.

In this manner, any data associated with a case may be used, for example, a serial number combined with a SKU, or a range of shipping or manufacturing dates for a certain product. As long as the data is available and the criteria is established, the evidence engine 140 can look for a particular issue and notify appropriate stakeholders that the issue is prevalent for a particular product/service, regardless of whether there is explicit documentation in the case record.

After the evidence engine 140 has classified structured and/or unstructured data within a document, all the relevant facts identified as a result of the classification may be combined into one “evidence” field and stored in a signatures database 142. In some embodiment, the evidence field may subsequently be used as a signature or a lookup value to identify feedback relating to the evidence. For example, in one embodiment, the lookup value may be used as an index into a lookup table (e.g., lookup table 152).

Turning now to the rules engine 150, it may be responsible for, among other things, extracting information from the lookup table 152 based on the evidence field built by the evidence engine 140. The use of a lookup table allows SMEs who have a wealth of experience troubleshooting particular types of cases to build troubleshooting steps based on relevant information in the case. For example, a rule stored in a rules database 151 can be as simple as if Fact 1 is in the evidence field, the issue can be resolved by doing XYZ, or a rule can be more complex such as, for example, if Facts 1, 2, and 6 are in the case and Fact 3 or 4 are not in the case, do XYZ. The flexibility of this approach and the range of possibilities enable the rule builders to construct highly specific rules based on the information found in the case while still having confidence in the classification of the text data. According to one embodiment, the information extracted from the lookup table 152 represents guidance in the form of a proposed resolution of the issue being experienced by the customer, a recommended next troubleshooting step in connection with evaluation of the issue, or other guidance relating to the issue. Alternatively, the information extracted from the lookup table 152 may represent feedback relating to a behavior or symptom of an item of interest. Depending upon the particular implementation, the information extracted from the lookup table 152 may be provided to end users 102 or agents 101 via the self-service portal 145 and/or may be distributed to appropriate stakeholders (e.g., members of a product/service support team for the product/service at issue, call center agents handling cases involving the particular issue or a similar issue, and the like) via the message delivery engine 155.

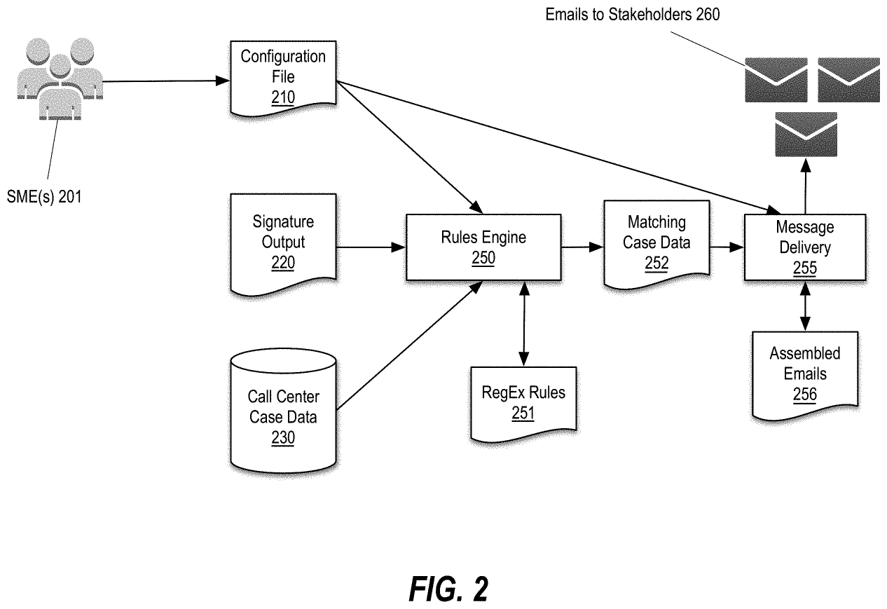

In the context of the present example, the message delivery engine 155 may be operable to notify appropriate stakeholders regarding a particular issue, a particular solution, and/or the existence of case records within the case records database 131 that match one or more rules. In one embodiment, based upon the results of the text analytics (e.g., the signatures stored in signatures database 142), various of the case records may be proactively updated to include appropriate guidance (e.g., proposed actions for issue resolution or troubleshooting steps) for use by the call center agents 101. Non-limiting examples of additional processing that may be performed by the rules engine 150 and the message delivery engine 155 are described below with reference to FIG. 2.

In some implementations, the self-service portal 145 may provide a web-based user interface to facilitate the ability on behalf of customers to “self-solve” their issues. For example, guided troubleshooting (GTS) as a Service (GaaS) may allow customers the ability to solve their issue “on demand” as an alternative to relying on a call center agent. Alternatively or additionally, the GaaS may be used by the call center agents rather than waiting for the periodic processing to run (e.g., periodic request of case records by the evidence engine 140). The self-service portal 145 may be operable to receive text-based information from an error string output by a product/service, to a case number (or other available unique identifier), to a file (e.g., an error log) and parse the input and send any guidance back directly to the user. In this manner, the user can access and input their issue(s) into the GaaS, which essentially gives the user access to their own SME that can walk them through the troubleshooting steps with the confidence that they are doing the same steps that the experts would be doing.

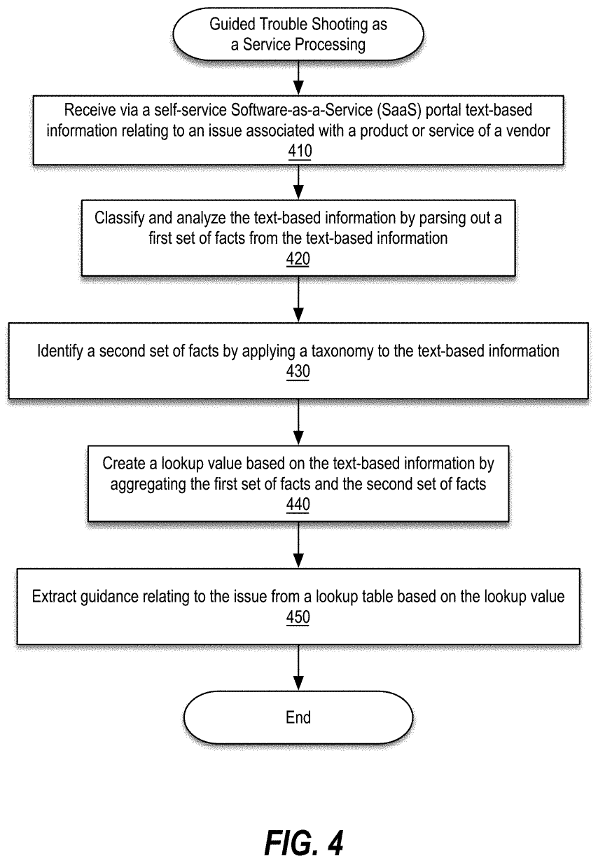

Those skilled in the art will appreciate various of the functional components of FIG. 1 may be combined and/or distributed in a manner different than depicted. For example, the contact center solution 135 may be integrated with the CRM service 130 and/or the functionality of the evidence engine 140 and the results engine 150 may combined. Similarly, one or more of the components of FIG. 1 may be further subdivided into multiple components. Additionally, while two clouds 120a-b are described in the above example, some or all of the components/services shown in one cloud may be implemented in the other. Non-limiting examples of processing that may be performed by the GaaS are described further below with reference to FIG. 4.

FIG. 2 shows a block diagram illustrating data flow associated with a rules engine 250 and a message delivery engine 255 in accordance with an example embodiment. The rules engine 250 and the message delivery engine 255 represent non-limiting examples of rules engine 150 and message delivery engine 155 of FIG. 1. In the context of the present example, the rules engine 250 receives input from a configuration file 210, signature output 220 (e.g., corresponding to the signatures database 142 of FIG. 1), and call center case data 230 (e.g., corresponding to the input case data database 141 or the case records database 131 of FIG. 1).

In one embodiment, the configuration file 210 operates as a configuration tool for the rules engine 250 and/or the message delivery engine 255, containing rules written by SMEs (e.g., SME(s) 201). The configuration file 210 may be represented in the form of a spreadsheet or other document format in which each rule includes one or more of the following elements that may be used by the rule engine 250 to compose an email:
Logical AND, ANDOR, OR, ANDNOT rule with elements SMEs want the rule engine 250 to look for in the signature output 220.
Email sections (e.g., potentially built as a relational database to facilitate reuse of existing elements):
   Header
   Body
   Footer
   Error Message: This may represent a placeholder in the email body that will be replaced by data coming from a text classification process (e.g., performed by the evidence engine 140).
   Guidance: This may represent a placeholder in the email body directed to call center agents (e.g., agents 101) that will be replaced by guidance pulled from a lookup table (e.g., lookup table 152).
   To, From, carbon copy (CC), and blind CC (BCC) lists

According to one embodiment, the rules engine 250 may ingest and transform the logical rules and corresponding elements into operands that act as regular expression (RegEx) searches, which may be stored in a RegEx rules database 251 (e.g., corresponding to rules database 151). After the RegEx searches have been generated, the rules engine 250 may apply the RegEx searches to the signature output 220, extract matching case data 252 (e.g., from the call center cases data 230), and provide the matching case data 252 to the message delivery engine 255 for notification processing.

In the context of the present example, notification processing performed by the message delivery engine 255 involves generating email messages to appropriate stakeholders for each case in the matching case data 252 in accordance with the email sections specified in the configuration file 210.

While in the context of the present example, notification to appropriate stakeholders is described with reference to automated generation and delivery of email correspondence, alternatively or additionally the message delivery engine 255 may inject information into case records (e.g., case records database 131) via an interface (e.g., API 132) associated with a CRM application (e.g., CRM application 130) utilized by the call center agents. For example, in one embodiment, guidance, feedback or instructions relating to a particular issue may be pre-populated within case records meeting certain criteria (e.g., involving a particular product/service issue) to facilitate call center agent interactions with customers and/or automate other tasks (e.g., pre-population of a part replacement recommendation, pre-population of a part order, and the like) that would otherwise be performed manually by the call center agents.

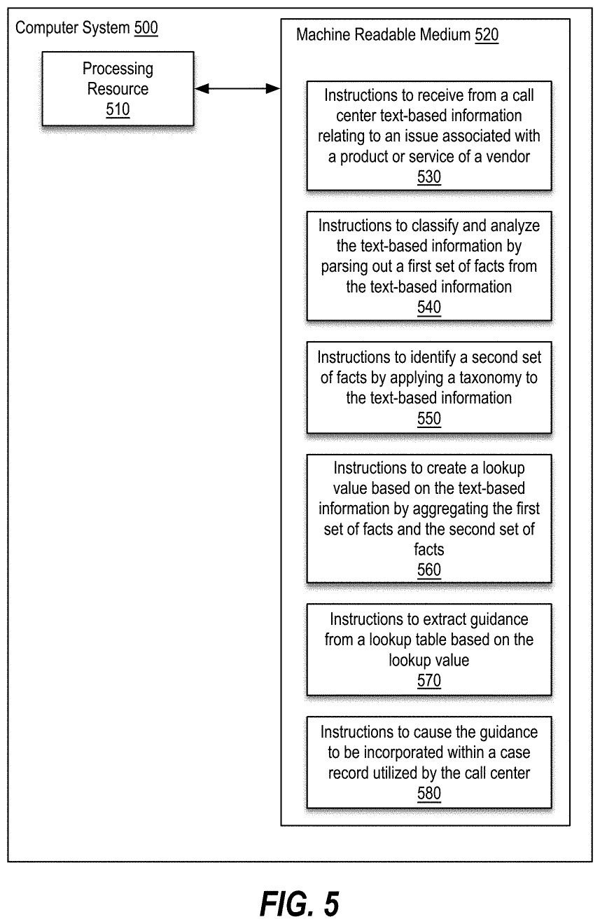

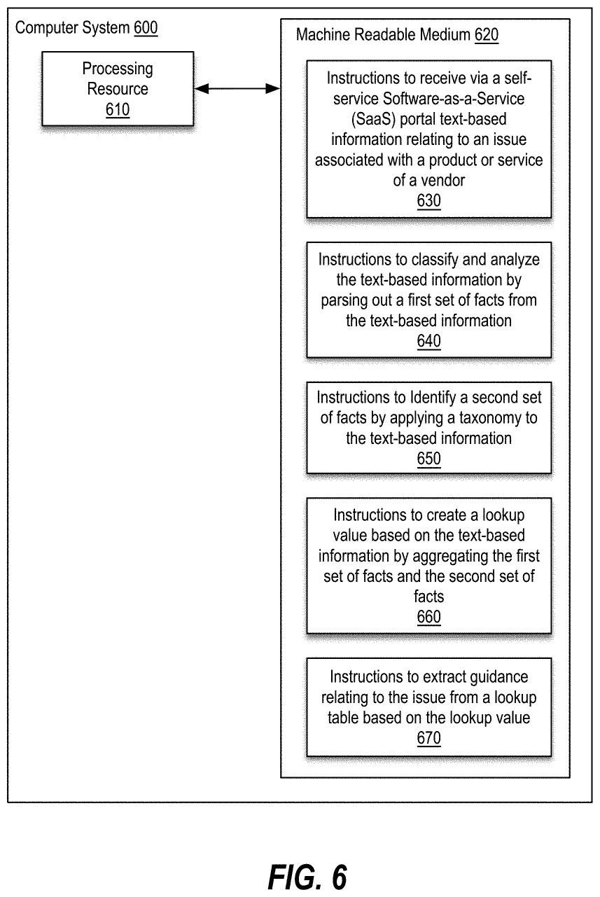

The various engines (e.g., evidence engine 140, rules engine 150, and message delivery engine 155) and other functional units (e.g., self-service portal 145) described herein and the processing described below with reference to the flow diagrams of FIGS. 3-4 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms, such as the computer systems described with reference to FIGS. 5-6 below.

FIG. 3 shows a flow diagram illustrating call center pre-population guidance processing in accordance with an example embodiment. At block 310, text-based information is received from a call center (e.g., supported by cloud 120a) relating to an issue associated with a product or service of a vendor. In one embodiment, the text-based information is received by an evidence engine (e.g., evidence engine 140) periodically requesting case records exhibiting the issue via an interface (e.g., API 132) of a CRM application (e.g., CRM application 130) utilized by call center agents (e.g., agents 101).

At block 320, the text-based information is classified and analyzed by parsing out a first set of facts from the text-based information. According to one embodiment, the first set of facts are extracted from one or more fields (e.g., case title, case notes, case number) of the case records received at block 310 by applying one or more regular expression searches (e.g., relating to a particular product/service issue) to the case records to identify relevant structured data (e.g., dates, serial numbers, error codes, and the like). A non-limiting example of a commercially available text analysis system that may configured to perform the regular expression searches is PolyAnalyst software available from Megaputer Intelligence Inc. of Bloomington, Ind.

At block 330, a second set of facts is identified by applying a taxonomy to the text-based information. According to one embodiment, the second set of facts are extracted from one or more fields (e.g., case title, case notes, case number) of the case records received at block 310 by applying a built-in function (e.g., taxonomy relating to a particular product/service issue) to the case records. A non-limiting example of a commercially available text analysis system that may configured to apply various built-in functions is PolyAnalyst software available from Megaputer Intelligence Inc. of Bloomington, Ind.

At block 340, a lookup value is create based on the text-based information by aggregating the first set of facts and the second set of facts identified in blocks 320 and 330, respectively. In one embodiment, the facts are concatenated together to form an evidence field. Prior to performing the concatenation, in one embodiment, each of the first set of facts and the second set of facts may be prepended with a delimiter indicative of the issue.

At block 350, guidance is extracted from a lookup table (e.g., lookup table 152) based on the lookup value. As noted above, the lookup table may contain troubleshooting steps specified by an SME based on relevant information found in the case records. According to one embodiment, the information extracted from the lookup table represents guidance in the form of a proposed resolution of the issue being experienced by the customer, a recommended next troubleshooting step in connection with evaluation of the issue, or other guidance relating to the issue.

At block 360, the guidance is caused to be incorporated within a case record. According to one embodiment, a message delivery engine (e.g., message delivery engine 155) causes the CRM application to incorporate the guidance extracted from the lookup table in block 350 to be included within an appropriate field of the case record by injecting the guidance into the CRM application via the API of the CRM application.

While in the context of the present example, call center pre-population is described with reference to pre-population of guidance within a call record, alternatively or additionally other pre-population processing may be performed. For example, based on the guidance, information regarding a particular part that should be sent to a customer may be documented within a case record and/or an on-site agent (e.g., at the customer or vendor site) may be tagged so as to alert the on-site agent regarding the issue and/or cause the guidance to show up in the on-site agent's feed within the CRM application.

In one embodiment, pre-population processing may involve automation of other tasks that would otherwise be performed manually by a call center agent. For example, a part order may be pre-populated to facilitate ordering and/or shipping of a part for a customer experiencing a problem with a product. Additionally or alternatively, other fields within the CRM application may be populated and/or one or more characteristics (e.g., severity or an elevation indicator) of a case record may be set.

FIG. 4 shows a flow diagram illustrating guided trouble shooting (GTS) as a service (GaaS) processing in accordance with an example embodiment. At block 410, text-based information relating to an issue associated with a product or service of a vendor is received via a self-service Software-as-a-Service (SaaS) portal (e.g., self-service portal 145). For example, the text-based information is transmitted from the self-service SaaS portal to an evidence engine (e.g., evidence engine 140). According to one embodiment, the text-based information includes an error string output by the product/service at issue, a unique identifier (e.g., a case number), and/or text-based information contained in a file (e.g., an error log associated with the product/service at issue) uploaded via the SaaS portal.

At block 420, the text-based information is classified and analyzed by parsing out a first set of facts from the text-based information. According to one embodiment, the first set of facts are extracted from the text-based information received at block 410 by applying one or more regular expression searches to the text-based information to identify relevant structured data (e.g., dates, serial numbers, error codes, and the like).

At block 430, a second set of facts is identified by applying a taxonomy to the text-based information. According to one embodiment, the second set of facts are extracted from the text-based information received at block 410 by applying a built-in function (e.g., taxonomy relating to a particular product/service issue) to the case records.

At block 440, a lookup value is create based on the text-based information by aggregating the first set of facts and the second set of facts identified in blocks 420 and 430, respectively. In one embodiment, all of the facts identified for a particular case are concatenated together to form an evidence field. Prior to performing the concatenation, in one embodiment, each of the first set of facts and the second set of facts may be prepended with a delimiter indicative of the issue.

At block 450, guidance relating to the issue is extracted from a lookup table (e.g., lookup table 152) based on the lookup value. As noted above, the lookup table may contain troubleshooting steps specified by an SME based on relevant information found in the case records. According to one embodiment, the information extracted from the lookup table represents guidance in the form of a proposed resolution of the issue being experienced by the customer, a recommended next troubleshooting step in connection with evaluation of the issue, or other guidance relating to the issue.

While in the context of the present example, the GaaS processing is described with reference to a self-service portal that is accessible to users external to the call center, in alternative embodiments, the self-service portal may alternatively be implemented internal to the call center with access limited, for example, to authorized call center agents.

FIG. 5 shows a block diagram of a computer system in accordance with an embodiment. In the example illustrated by FIG. 5, computer system 500 includes processing resource 510 coupled to non-transitory, machine readable medium 520 encoded with instructions to perform a private cloud gateway creation processing. Processing resource 510 may include a microcontroller, a microprocessor, CPU core(s), GPU core(s), an ASIC, an FPGA, and/or other hardware device suitable for retrieval and/or execution of instructions from machine readable medium 520 to perform the functions related to various examples described herein. Additionally or alternatively, processing resource 510 may include electronic circuitry for performing the functionality of the instructions described herein.

Machine readable medium 520 may be any medium suitable for storing executable instructions. Non-limiting examples of machine readable medium 520 include RAM, ROM, EEPROM, flash memory, a hard disk drive, an optical disc, or the like. Machine readable medium 520 may be disposed within computer system 500, as shown in FIG. 5, in which case the executable instructions may be deemed “installed” or “embedded” on computer system 500. Alternatively, machine readable medium 520 may be a portable (e.g., external) storage medium, and may be part of an “installation package.” The instructions stored on machine readable medium 520 may be useful for implementing at least part one or more of the methods described herein.

In the context of the present example, machine readable medium 520 is encoded with a set of executable instructions 530-580. It should be understood that part or all of the executable instructions and/or electronic circuits included within one block may, in alternate implementations, be included in a different block shown in the figures or in a different block not shown.

Instructions 530, upon execution, may cause processing resource 510 to receive from a call center text-based information relating to an issue associated with a product or service of a vendor. In one embodiment, instructions 530 may be useful for performing block 310 of FIG. 3.

Instructions 540, upon execution, may cause processing resource 510 to classify and analyze the text-based information by parsing out a first set of zero or more facts from the text-based information. In one embodiment, instructions 540 may be useful for performing block 320 of FIG. 3.

Instructions 550, upon execution, may cause processing resource 510 to identify a second set of zero or more facts by applying a taxonomy to the text-based information. In one embodiment, instructions 530 may be useful for performing block 330 of FIG. 3.

Instructions 560, upon execution, may cause processing resource 510 to create a lookup value based on the text-based information by aggregating the first set of facts and the second set of facts. In one embodiment, instructions 560 may be useful for performing block 340 of FIG. 3.

Instructions 570, upon execution, may cause processing resource 510 to extract guidance from a lookup table based on the lookup value. In one embodiment, instructions 570 may be useful for performing block 350 of FIG. 3.

Instructions 580, upon execution, may cause processing resource 510 to cause the guidance to be incorporated within a case record utilized by the call center. In one embodiment, instructions 580 may be useful for performing block 360 of FIG. 3.

FIG. 6 is a block diagram of a computer system in accordance with an alternative embodiment. In the example illustrated by FIG. 6, computer system 600 includes a processing resource 610 coupled to a non-transitory, machine readable medium 620 encoded with instructions to perform a proactive auto-scaling method in accordance with a public cloud embodiment. As above, the processing resource 610 may include a microcontroller, a microprocessor, central processing unit core(s), an ASIC, an FPGA, and/or other hardware device suitable for retrieval and/or execution of instructions from the machine readable medium 620 to perform the functions related to various examples described herein. Additionally or alternatively, the processing resource 610 may include electronic circuitry for performing the functionality of the instructions described herein.

The machine readable medium 620 may be any medium suitable for storing executable instructions. Non-limiting examples of machine readable medium 620 include RAM, ROM, EEPROM, flash memory, a hard disk drive, an optical disc, or the like. The machine readable medium 620 may be disposed within the computer system 600, as shown in FIG. 6, in which case the executable instructions may be deemed “installed” or “embedded” on the computer system 600. Alternatively, the machine readable medium 620 may be a portable (e.g., external) storage medium, and may be part of an “installation package.” The instructions stored on the machine readable medium 620 may be useful for implementing at least part of the methods described herein.

In the context of the present example, the machine readable medium 620 is encoded with a set of executable instructions 630-670. It should be understood that part or all of the executable instructions and/or electronic circuits included within one block may, in alternate implementations, be included in a different block shown in the figures or in a different block not shown. For example, in one embodiment, the set of executable instructions 530-580 of FIG. 5 and the set of executable instructions 630-670 may be installed on the same computer system.

Instructions 630, upon execution, may cause the processing resource 610 to receive via a self-service SaaS portal text-based information relating to an issue associated with a product or service of a vendor. In one embodiment, instructions 630 may be useful for performing block 410 of FIG. 4.

Instructions 640, upon execution, may cause the processing resource 610 to classify and analyze the text-based information by parsing out a first set of zero or more facts from the text-based information. In one embodiment, instructions 640 may be useful for performing block 420 of FIG. 4.

Instructions 650, upon execution, may cause the processing resource 610 to identify a second set of zero or more facts by applying a taxonomy to the text-based information. In one embodiment, instructions 650 may be useful for performing block 430 of FIG. 4.

Instructions 660, upon execution, may cause the processing resource 610 to create a lookup value based on the text-based information by aggregating the first set of facts and the second set of facts. In one embodiment, instructions 660 may be useful for performing block 440 of FIG. 4.

Instructions 670, upon execution, may cause the processing resource 610 to extract guidance relating to the issue from a lookup table based on the lookup value. In one embodiment, instructions 670 may be useful for performing block 450 of FIG. 4.

In the foregoing description, numerous details are set forth to provide an understanding of the subject matter disclosed herein. However, implementation may be practiced without some or all of these details. Other implementations may include modifications, combinations, and variations of the details discussed above. It is intended that the following claims cover such modifications, combinations, and variations.

What is claimed is:

1. A method performed by one or more processing resource of one or more computer systems, the method comprising:
receiving via a self-service Software-as-a-Service (SaaS) portal text-based information relating to an issue associated with a product or service of a vendor, wherein the text-based information includes one or both of structured data and unstructured data;
classifying and analyzing the text-based information by parsing out a first set of facts from the structured data;
identifying a second set of facts by applying a taxonomy to the text-based information;
creating a lookup value based on the text-based information by aggregating the first set of facts and the second set of facts; and
extracting guidance from a lookup table based on the lookup value, wherein the guidance represents a proposed resolution of the issue, a recommended next troubleshooting step in connection with evaluation of the issue, or other guidance relating to the issue.

2. The method of claim 1, wherein said classifying and analyzing includes correlating the first set of facts with one or more facts extracted from a data source other than a plurality of case records maintained by a call center.

3. The method of claim 1, wherein the guidance is based on knowledge of a subject matter expert associated with the vendor.

4. The method of claim 1, wherein accessibility to the self-service SaaS portal is limited to call center agents providing product/service support on behalf of the vendor.

5. The method of claim 1, wherein the self-service SaaS portal is accessible to customers of the vendor.

6. The method of claim 1, wherein the text-based information comprises:
an error message or an error code output by the product or service;
a reading from a sensor associated with the product or service; or
a status of a gauge or an indicator triggered by the sensor.

7. A method performed by one or more processing resource of one or more computer systems, the method comprising:
receiving, from a call center, text-based information relating to an issue associated with a product or service of a vendor, wherein the text-based information includes one or both of structured data and unstructured data;
classifying and analyzing the text-based information by parsing out a first set of facts from the structured data;
identifying a second set of facts by applying a taxonomy to the text-based information;
creating a lookup value based on the text-based information by aggregating the first set of facts and the second set of facts;
extracting guidance from a lookup table based on the lookup value, wherein the guidance represents feedback relating to the issue; and
causing the guidance to be incorporated within a case record of a plurality of case records utilized by the call center.

8. The method of claim 7, wherein said classifying and analyzing includes correlating the first set of facts with one or more facts extracted from a data source other than the plurality of case records.

9. The method of claim 7, wherein the guidance is based on knowledge of a subject matter expert associated with the vendor.

10. The method of claim 7, further comprising pre-populating a part order for the product based on the guidance.

11. A non-transitory machine readable medium storing instructions executable by a processing resource of a computer system, the non-transitory machine readable medium comprising instructions to:
receive via a self-service Software-as-a-Service (SaaS) portal text-based information relating to an issue associated with a product or service of a vendor, wherein the text-based information includes one or both of structured data and unstructured data;
classify and analyze the text-based information by parsing out a first set of facts from the structured data;
identify a second set of facts by applying a taxonomy to the text-based information;
create a lookup value based on the text-based information by aggregating the first set of facts and the second set of facts; and
extract guidance from a lookup table based on the lookup value, wherein the guidance represents a proposed resolution of the issue, a recommended next troubleshooting step in connection with evaluation of the issue, or other guidance relating to the issue.

12. The non-transitory machine readable medium of claim 11, wherein classification and analysis of the text-based information includes correlating the first set of facts with one or more facts extracted from a data source other than a plurality of case records maintained by a call center.

13. The non-transitory machine readable medium of claim 11, wherein the guidance is based on knowledge of a subject matter expert associated with the vendor.

14. The non-transitory machine readable medium of claim 11, wherein accessibility to the self-service SaaS portal is limited to call center agents providing product/service support on behalf of the vendor.

15. The non-transitory machine readable medium of claim 11, wherein the self-service SaaS portal is accessible to customers of the vendor.

16. The non-transitory machine readable medium of claim 11, wherein the text-based information comprises:
an error message or an error code output by the product or service;
a reading from a sensor associated with the product or service; or
a status of a gauge or an indicator triggered by the sensor.

17. A non-transitory machine readable medium storing instructions executable by a processing resource of a computer system, the non-transitory machine readable medium comprising instructions to:
receive, from a call center, text-based information relating to an issue associated with a product or service of a vendor, wherein the text-based information includes one or both of structured data and unstructured data;
classify and analyze the text-based information by parsing out a first set of facts from the structured data;
identify a second set of facts by applying a taxonomy to the text-based information;
create a lookup value based on the text-based information by aggregating the first set of facts and the second set of facts;
extract guidance from a lookup table based on the lookup value, wherein the guidance represents feedback relating to the issue; and
cause the guidance to be incorporated within a case record of a plurality of case records utilized by the call center.

18. The non-transitory machine readable medium of claim 17, wherein classification and analysis of the text-based information includes correlating the first set of facts with one or more facts extracted from a data source other than the plurality of case records.

19. The non-transitory machine readable medium of claim 17, wherein the guidance is based on knowledge of a subject matter expert associated with the vendor.

20. The non-transitory machine readable medium of claim 17, wherein the instructions further cause the processing resource to pre-populate a part order for the product based on the guidance.
